(19) United States
(12) Patent Application Publication
(10) Pub. No.: US 2006/0008385 A1
(43) Pub. Date: Jan. 12, 2006

(54) Method and apparatus for an analytical instrument oven module with variable speed fan

(76) Inventor: Sammye Elizabeth Millor II, New Castle, DE (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/887,124

(22) Filed: Jul. 8, 2004

(51) Int. Cl. B32B 27/04; G01N 30/02

(52) U.S. Cl. 422/89; 422/99

(57) ABSTRACT

An oven module for use in controlling the temperature of a component of an analytical instrument. The oven module has an enclosure to accommodate the component and a heating element. The enclosure has a fluid intake and a fluid outlet. A variable speed fan, mounted within the enclosure, is operable to circulate fluid within the enclosure and to draw cooling fluid through the fluid intake into the enclosure. The variable speed fan is operated at an increased speed when cooling of the oven is required.

### FIELD

This invention relates generally to methods and apparatus for controlling temperature profiles in an oven module of an analytical instrument. More particularly, this invention relates to the use of a variable speed fan in an oven module of an analytical instrument.

### BACKGROUND

The performance of an analytical instrument is often susceptible to temperature variations. The temperature of one or more components of an analytical instrument, such as gas chromatograph, is typically controlled by locating the component in a temperature-controlled chamber. The chamber may contain heating or cooling devices or a combination of such devices. When temperatures higher than the ambient temperature are required, an oven module is used. For example, for precise work, the temperature of a gas chromatograph separator column is controlled to within tenths of a degree. The temperature is controlled by placing the chromatographic column in an oven.

In automated testing, overall throughput is dependent upon the duration of the sample analysis cycle. Reducing the duration of the sample analysis cycle increases throughput.

One method for reducing the duration of the sample analysis cycle is to increase the heating rate of the oven during analysis. This requires the user to translate the analysis method parameters, such as gas pressures and flows, to account for the new heating rate. Although computer applications exist to assist in this process, often times many iterations must be performed in order to fine-tune the new method. Finally, a large heating rate may also lead to an unacceptable loss of resolution or dynamic range.

Another method for reducing the duration of the sample analysis cycle is to increase the cooling rate of the oven between analyses. One strategy to accomplish this would be to reduce the thermal mass of the oven. With less material to heat, there will be less energy stored during a sample analysis cycle and therefore less energy to remove during cooling. Similarly, less energy will be required during heating. For example, the wall thickness of the oven could be reduced. There is a practical limit to thinning the wall due to reduced wall rigidity that can lead to a range of problems from poor aesthetics to the inability to effectively mount objects to the oven wall. Another possibility is to decrease the overall oven size or volume of the oven module. Again, physical limitations arise because this option reduces the space available for GC columns and other accessories and makes maintenance more difficult.

### SUMMARY

The present invention relates generally to a method and apparatus for increasing the cooling rate of an oven module of an analytical instrument.

The invention relates to an oven module for use in controlling the temperature of a component of an analytical instrument. The oven module has an enclosure to contain the component. The enclosure has a fluid intake and a fluid outlet. A variable speed fan, mounted at least partially within the enclosure, is operable to circulate fluid within the enclosure. The variable speed fan is also used to draw cooling fluid through the fluid intake into the enclosure. The variable speed fan is operated at an increased speed when cooling of the oven is required so as to increase the rate of cooling.

### BRIEF DESCRIPTION OF THE DRAWINGS

The novel features believed characteristic of the invention are set forth in the appended claims. The invention itself, however, as well as the preferred mode of use, and further objects and advantages thereof, will best be understood by reference to the following detailed description of an illustrative embodiment when read in conjunction with the accompanying drawing(s), wherein:

FIG. 1 is a diagrammatic representation of an exemplary gas chromatograph.

FIG. 2 is an internal view of an oven module in accordance with an embodiment of the invention.

FIG. 3 is a cross-sectional view of an oven module in accordance with an embodiment of the invention.

FIG. 4 is a graph showing an exemplary relationship between the fan speed and the cooling time in accordance with an embodiment of the present invention.

### DETAILED DESCRIPTION

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description below, like reference numerals are used to describe the same, similar or corresponding parts in the several views of the drawings.

The present invention relates to a method and apparatus for reducing the cool-down time of an oven module of an analytical instrument, such as a Gas Chromatograph.

The oven module of the analytical instrument is provided with a variable speed fan that may be operated at a first speed to stir fluid in the oven module during an analysis period and operated at a second, higher, speed to increase the rate of cooling of the oven during a cool-down period. During the cool-down period, the variable speed fan draws cool air into the oven module.

The speed of the fan may be varied during the cool-down period to control the temperate profile during cooling.

One or more additional fans may be used in combination with the variable speed fan to increase the rate of cooling still further.

The following description of the invention will be directed to an analytical instrument in the form of a Gas Chromatograph. However, the teachings herein may be applied to other analytical instruments, such as other types of chromatographs, and other instruments for the detection or analysis of physical parameters or phenomena.

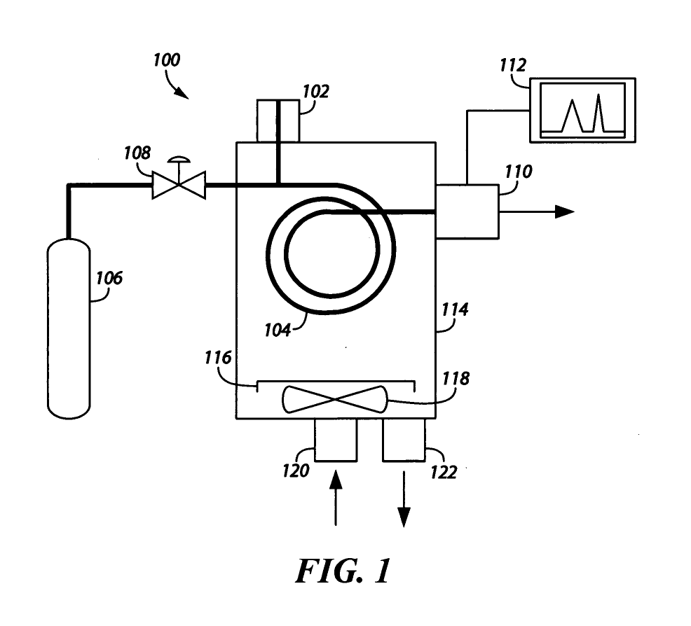

FIG. 1 is a diagrammatic representation of an exemplary gas chromatograph 100. A sample of material to be analyzed is injected into injector port 102 onto the head of a chromatographic separator column 104. The sample is transported through the separator column 104 by the flow of an inert, gaseous mobile phase, called the carrier gas. The flow of carrier gas from supply 106 is controlled by flow controller 108. The column itself 104 may contain a liquid stationary phase, which is adsorbed onto the surface of an inert solid. Commonly used carrier gases include nitrogen, helium, argon, and carbon dioxide. The choice of carrier gas is often dependant upon the type of detector used.

The various constituents of the sample are forced under pressure through the separation column 104 by the flow of gas and are detected by detector 110. The output from detector 110 is recorded by an external computer 112 or other recording device. Overall control of the analysis process may be provided by the external computer 112 or by a controller implemented as firmware in the gas chromatograph 100. The sample components have different mobilities and so become separated from each other as they travel through the separation column 104. Consequently, the sample components arrive at the detector 110 at different times. The injector 102 and detector 110 may be combined in a modular assembly.

The separation column 104 is mounted inside an oven module 114. The oven module 114 is heated by heating coils located within the fan shroud 116. A fluid movement device, such as a stirring fan 118, operates to move fluid over the heating and fan shroud 116 to heat the fluid in the oven and also to stir the fluid in the oven to keep the oven temperature uniform. While a stirring fan is used in this embodiment, it will be apparent to those of ordinary skill in the art that other types of fluid movement devices may be used as appropriate for the gas or liquid in the oven.

In one embodiment of the present invention the speed of the stirring fan 118 is operated at a first rate during chromatographic analysis and at a second, higher, rate during cooling. This increases the cooling rate and facilitates increased throughput during automated testing. The speed of the fan may be controlled by firmware in the instrument or by the external computer 112.

In a still further embodiment, firmware in the instrument controls the heating element 116 and the fan 118 to produce a predetermined temperature profile within the oven module 114 during chromatographic analysis or cooling.

The fluid in the oven may be a gas, such as air, helium or nitrogen, or it may be a liquid, such as water.

During cool down, the stirring fan 118 operates to draw cooling fluid into the oven from the fluid intake 120, circulate it against the oven walls and expel it from the fluid outlet 122. To accommodate this, the fluid intake 120 is ducted to a low-pressure region behind the stirring fan 118.

In FIG. 1, the analytical instrument is a gas chromatograph, and one of its components—the separation column 104—is placed substantially within the oven module 114. Other analytical instruments may have various components that are located at least partially within an oven module for heating.

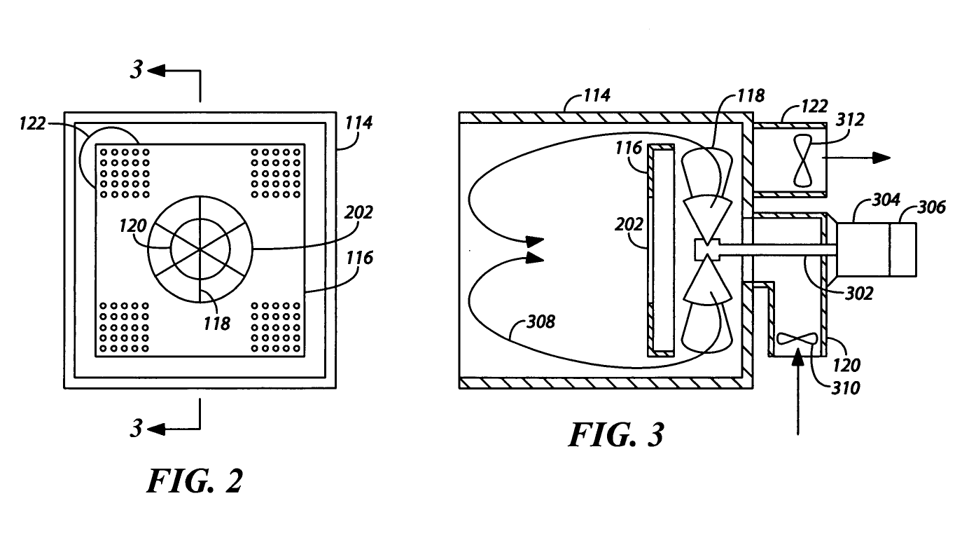

FIG. 2 is an internal view of an exemplary oven module 114 in accordance with an embodiment of the present invention. In this embodiment, the fluid intake 120 is aligned co-axially with a stirring fan 118, which may be implemented as a radial fan. Shroud 116 incorporates heating elements, such as resistive wire. An aperture 202 in shroud 116 allows fluid to return to the low pressure region at the center of the stirring fan 118.

FIG. 3 is a sectional view through the cross-section 3-3 of the oven module shown in FIG. 2. FIG. 3 shows the positions of the intake 120 and outlet 122 relative to the stirring fan 118 and heating element with shroud 116. The stirring fan 118, which is capable of operating at variable speed, includes a plurality of blades attached to a central hub that is in turn coupled via shaft 302 to a variable speed motor 304. A power supply (not shown) supplying power to the variable speed motor 304 is controlled by a speed controller 306. The speed controller 306 may be incorporated in the same assembly as the fan motor 304 or may be separated from it.

The speed controller 306 may operate in response to control signals from firmware within the instrument.

In operation, the stirring fan 118 produces a region of low pressure near its axis, which draws cool fluid into the oven through the intake 120. Additionally, the stirring fan 118 produces a region of high pressure at its periphery that forces hot fluid out through the outlet 122. Cool fluid from the intake 120 is circulated around the edges of the heating element and shroud 116, across the walls of the oven 114 and back through the aperture 202 in the shroud. This results in a toroidal circulation denoted by arrow 308. Other variable speed fluid moving devices, such as axial fans, centrifugal fans and blowers, may be used instead of the radial fan.

In accordance with one aspect of the present invention, the speed of the stirring fan 118 is increased during cooling so as to draw cool fluid into the oven at an increased rate during cooling.

For efficient operation, the intake 120 is positioned in a low pressure region created by the stirring fan 118, while the outlet 122 is positioned in a region of higher pressure. The stirring fan 118 is positioned to cause a fluid flow across the heating element and maintains a substantially uniform temperature throughout the oven during chromatographic analysis. Also, the stirring fan 118 is positioned to cause fluid flow across the walls of the oven during the cool-down period.

Optionally, booster fans are installed in the intake 120, the outlet 122, or both the intake and outlet, so as to increase the fluid flow further during cooling. Mounting a booster fan 310 in the inlet allows the fan to be in a cooler environment. Mounting a booster fan 312 in the outlet requires the fan motor to be robust to heat and may require the motor to be placed outside of the flow. The booster fans may be switched off during heating so as to minimize the maximum current draw of the instrument.

In one embodiment, the fluid intake and fluid outlet are closed during sample analysis, when temperature in the oven is required to be increased or maintained. The fluid intake and fluid outlet are opened when cooling is required.

In one embodiment of the present invention, a gas chromatograph is provided with a variable-speed fan. The variable speed fan is operated at a first speed to provide stirring of the fluid during chromatography and at a second, higher, speed to draw fluid into the oven during cooling. In one embodiment, the variable-speed fan is driven by a D.C. motor. In a further embodiment, the variable-speed fan is driven by an A.C. motor having a speed controller.

The use of a variable speed fan has advantages over the use of single fixed speed fan. To achieve rapid cooling with a single fixed speed fan would require that the fixed speed fan be operated at high speed during cooling. If the fan were operated at the same high speed during chromatographic analysis, the result would be increased noise, vibration, energy consumption, and wear on the fan and motor. In particular, since the both the stirring fan and the heating element are operated at the same time during chromatographic analysis, the maximum energy consumption of the whole system is increased, requiring a more powerful power supply or reducing the amount of energy available for heating. Additionally, some chromatographic detectors are very sensitive to vibration.

The use of a combination of two fixed speed fans (one for stirring and one for cooling) avoids these disadvantages but increases the number of parts and the cost. Furthermore, retro-fitting a second fan is more difficult.

In one embodiment, the fan motor is positioned outside of the fluid flow, and thermally insulated from it, so as to prevent heat from the fan motor entering the oven and heat from the oven overheating the fan motor. In this embodiment, the fan blades and shaft are positioned in the fluid flow, but the motor is mounted remotely to protect it from the oven heat. However, heat generated in the motor is conducted through the motor shaft and fan blades which are in the oven. Although at high temperatures this may not be a significant source of heat relative to the heat stored in the oven, it becomes more important near ambient or at cryogenic temperatures. Also, the act of stirring adds energy to the system. Hence, minimizing the flow speed near ambient is important.

In a further embodiment, the fan motor is positioned within the fluid flow. In this embodiment, the speed of the fan may be varied during the cooling period so as to balance the cooling capacity of the fluid drawn in by the fan and the heat created by the fan motor.

Table 1 summarizes some exemplary cooling times for an Agilent Technologies 6890 Gas Chromatograph fitted with a variable speed D.C. fan for both stirring and cooling. The table shows the time for the oven to cool from 350° C. to 40° C. By increasing the fan rate, the cooling time was reduced by up to 45% compared with a constant speed A.C. fan (rated at 1735 RPM with no load).

TABLE 1

| | Cooling Time, | |
|---|---|---|
| RPM | (minutes) | Time Change (%) |
| 1350 | 9.48 | +27 |
| 1500 | 7.88 | +5.6 |
| 1620 | 7.33 | −1.9 |
| 1800 | 6.68 | −10.5 |
| 1950 | 6.38 | −14.6 |
| 2100 | 5.73 | −23.2 |
| 2250 | 5.46 | −26.9 |
| 2400 | 5.35 | −28.4 |
| 2550 | 5.13 | −31.3 |
| 2700 | 4.73 | −36.7 |
| 2850 | 4.61 | −38.3 |
| 3000 | 4.70 | −37.0 |
| 3150 | 4.40 | −41.1 |
| 3350 | 4.10 | −45.1 |

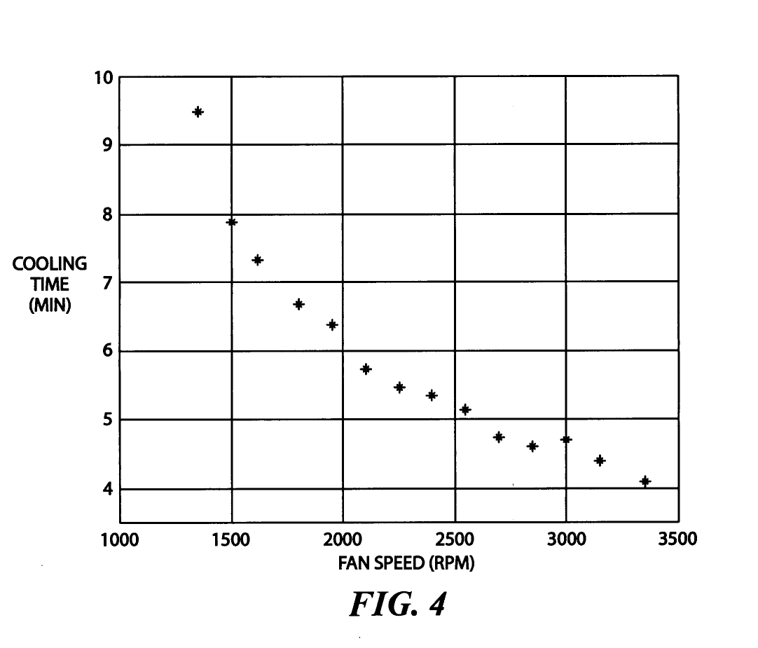

The results in Table 1 are shown graphically in FIG. 4. The graph shows the time to cool down from 350° C. to 40° C. as a function of the fan speed.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. An oven module for use in controlling the temperature of a component of an analytical instrument, comprising:
an enclosure of sufficient size and shape to accommodate the component, the enclosure having a fluid intake and a fluid outlet to accommodate circulation of fluid through the enclosure; and
a variable speed fan operable at a first speed to circulate fluid within the enclosure and at a second speed, higher than the first speed, to draw cooling fluid through the fluid intake into the enclosure.

2. An oven module in accordance with claim 1, wherein the analytical instrument is operable to analyze a sample in an analysis period during which the temperature of the oven module is higher than an ambient temperature, and wherein the temperature of the oven module is reduced during a cool-down period following an analysis period, and wherein the variable speed fan is operable to rotate at a higher speed during the cool-down period than during the analysis period.

3. An oven module in accordance with claim 2, further comprising a booster fan situated within the fluid intake and operable to increase fluid flow through the oven module during the cool-down period.

4. An oven module in accordance with claim 2, further comprising a booster fan situated within the fluid outlet and operable to increase fluid flow through the oven module during the cool-down period.

5. An oven module in accordance with claim 1, wherein the variable speed fan is selected from a group of fans consisting of an axial fan, a centrifugal fan and a radial fan.

6. A gas chromatograph having an improved cooling rate, the gas chromatograph comprising:
an enclosure having a fluid intake and a fluid outlet and operable in an cycle including a heating period and a cooling period;
a chromatographic separation column mounted within the enclosure; and
a variable speed fan operable at a first speed to circulate fluid within the enclosure during the heating period and at a second speed, higher than the first speed, to draw cooling fluid through the fluid intake into the enclosure during the cooling period.

7. A gas chromatograph in accordance with claim 6, further comprising a fan-speed controller, operable to control the variable speed fan to be at a first speed when the gas chromatograph is analyzing a sample and to be at a second speed when the enclosure is cooling.

8. A gas chromatograph in accordance with claim 6, wherein the speed of the variable speed fan is varied during the cooling period to maximize the rate of cooling.

9. A method for increasing the cooling rate of an oven of an analytical instrument, the method comprising:
operating a variable speed fan at a first speed during an analysis of a sample by the analytical instrument to circulate fluid within the oven and maintain a substantially uniform temperature throughout the oven; and
operating the variable speed fan at an increased speed during a cooling period following the analysis of the sample by the analytical instrument, to draw cooling fluid into the oven through a fluid intake and increase the rate of cooling of the oven.

10. A method in accordance with claim 9, further comprising varying the speed of the variable speed fan during the cooling period to maximize the rate of cooling.

11. A method in accordance with claim 9, further comprising operating a booster fan in the fluid intake to increase the rate of the cooling of the oven further.

12. A method in accordance with claim 9, further comprising:
closing the fluid intake during the analysis of a sample by the analytical instrument;
closing an fluid outlet from the oven during the analysis of a sample by the analytical instrument;
opening the fluid intake during the cooling period; and
opening the fluid outlet during the cooling period.

13. A method in accordance with claim 9, wherein the analytical instrument is a gas chromatograph.

14. A temperature control means for controlling the temperature of a component of an analytical instrument, comprising:
a housing of sufficient size and shape to accommodate the component, the housing having a fluid intake and a fluid outlet;
a heater means for heating the component; and
a first fluid movement means operable at a first speed to circulate fluid within the housing during heating of the component and at a second speed to draw fluid through the fluid intake into the housing during cooling of the component.

15. A temperature control means in accordance with claim 14, further comprising a second fluid movement means located within the fluid intake and operable to increase fluid flow through the oven module during the cooling of the component.

16. A temperature control means in accordance with claim 14, further comprising a second fluid movement means, the second fluid movement means being located within the fluid outlet and operable to increase fluid flow through the oven module during the cooling of the component.

17. A temperature control means in accordance with claim 14, wherein the first speed of the fluid movement means is lower than the second speed of the fluid movement means.

18. A temperature control means in accordance with claim 14, further comprising a control means operable to control the fluid movement means and the heater means.

19. A temperature control means in accordance with claim 14, wherein the first fluid movement means is operable at a variable speed during cooling of the component.

20. A temperature control means in accordance with claim 14, wherein the analytical instrument is a gas chromatograph and wherein the component of the analytical instrument is a chromatographic separation column.
